(19) United States
(12) Patent Application Publication
(10) Pub. No.: US 2025/0296433 A1
(43) Pub. Date: Sep. 25, 2025

(54) FUEL TANK PROCESSING APPARATUS

(71) Applicant: SUBARU CORPORATION, Tokyo (JP)

(72) Inventors: Toshimitsu WAKI, Tokyo (JP); Akihiro TAKEMURA, Tokyo (JP); Tetsuya KANEKO, Tokyo (JP)

(21) Appl. No.: 19/041,660

(22) Filed: Jan. 30, 2025

(30) Foreign Application Priority Data
Mar. 25, 2024 (JP) 2024-048602

(51) Int. Cl. B60K 15/035

(52) U.S. Cl. CPC B60K 15/035; B60K 2015/03576

(57) ABSTRACT

A fuel tank processing apparatus including a discharge path, a valve, and a calculation controller. Gas discharged from a fuel tank is to flow through the discharge path. The valve is disposed in the discharge path. The calculation controller is configured to adjust an opening degree of the valve. The calculation controller is configured to adjust the opening degree of the valve during supplying of fuel to the fuel tank based on a change in condition that occurs when an internal pressure of the fuel tank is reduced.

### CROSS-REFERENCE TO RELATED APPLICATIONS

The present application claims priority from Japanese Patent Application No. 2024-048602 filed on Mar. 25, 2024, the entire contents of which are hereby incorporated by reference.

### BACKGROUND

The disclosure relates to a fuel tank processing apparatus that adjusts the flow of gas during refueling.

In a vehicle including an engine as a drive source, fuel supplied to the engine is stored in a fuel tank. The fuel tank is refilled by introducing fuel into the fuel tank through a fuel filler port. During refueling, vaporized gas is discharged to the outside through the fuel filler port and a drain line. The amount of vaporized gas discharged to the outside through the fuel filler port and the drain line is regulated by laws in each country. To comply with the laws and regulations, the vaporized gas generated during refueling is caused to flow through a circulation line for circulation near the fuel filler port and the drain line at balanced flow rates. Japanese Unexamined Patent Application Publication No. 2011-185227, Japanese Unexamined Patent Application Publication No. 2014-77422, and Japanese Unexamined Patent Application Publication No. 2002-317708 describe disclosures related to the pressure and path of gas generated in the fuel tank.

### SUMMARY

An aspect of the disclosure provides a fuel tank processing apparatus including a discharge path, a valve, and a calculation controller. Gas discharged from a fuel tank is to flow through the discharge path. The valve is disposed in the discharge path. The calculation controller is configured to adjust an opening degree of the valve. The calculation controller is configured to adjust the opening degree of the valve during supplying of fuel to the fuel tank based on a change in condition that occurs when an internal pressure of the fuel tank is reduced.

An aspect of the disclosure provides a fuel tank processing apparatus including a discharge path, a valve, and circuitry. Gas discharged from a fuel tank is to flow through the discharge path. The valve is disposed in the discharge path. The circuitry is configured to adjust an opening degree of the valve. The circuitry is configured to adjust the opening degree of the valve during supplying of fuel to the fuel tank based on a change in condition that occurs when an internal pressure of the fuel tank is reduced.

### BRIEF DESCRIPTION OF THE DRAWINGS

The accompanying drawings are included to provide a further understanding of the disclosure and are incorporated in and constitute a part of this specification. The drawings illustrate an embodiment and, together with the specification, serve to describe the principles of the disclosure.

FIG. 1 is a block diagram illustrating a configuration of a vehicle including a fuel tank processing apparatus according to an embodiment of the disclosure;

FIG. 2 is a flowchart of a method by which the fuel tank processing apparatus according to the embodiment of the disclosure changes an opening degree of a solenoid valve;

FIG. 3 is a flowchart of a method by which the fuel tank processing apparatus according to the embodiment of the disclosure estimates a pressure drop in a discharge path;

FIG. 4 is a flowchart of a method by which the fuel tank processing apparatus according to the embodiment of the disclosure estimates an adjustment value for the solenoid valve;

FIG. 5 is a block diagram illustrating a path along which the fuel tank processing apparatus according to the embodiment of the disclosure causes gas to flow to reduce the internal pressure of a fuel tank;

FIG. 6A illustrates tables used by the fuel tank processing apparatus according to the embodiment of the disclosure to estimate a pressure drop in the discharge path;

FIG. 6B is a table used by the fuel tank processing apparatus according to the embodiment of the disclosure to estimate an adjustment value for the opening degree of the solenoid valve;

FIG. 7 is a conceptual diagram illustrating the adjustment of the opening degree of the solenoid valve by the fuel tank processing apparatus according to the embodiment of the disclosure; and

FIG. 8 is a block diagram illustrating paths along which the fuel tank processing apparatus according to the embodiment of the disclosure causes gas to flow during refueling.

### DETAILED DESCRIPTION

The above-described disclosures have room for improvement in effectively guiding gas generated in the fuel tank to the outside during refueling.

For example, a discharge path and components, such as valves, through which gas is discharged to the outside from the fuel tank deteriorate over time. For example, a duct that serves as a discharge path may become crushed or deformed. When significant deterioration occurs, it becomes difficult to balance the flow rate between the circulation line and the drain line as described above.

In addition, the components, such as valves, provided in the discharge path have different performances due to, for example, tolerances during processing. The differences between the performances of the components also make it difficult to balance the flow rate between the circulation line and the drain line.

It is desirable to provide a fuel tank processing apparatus that maintains good balance between paths through which gas is discharged from the fuel tank to the outside during refueling.

A fuel tank processing apparatus 11 according to an embodiment of the disclosure will now be described in detail with reference to the drawings. Note that the following description is directed to an illustrative example of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiment which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same numerals to avoid any redundant description.

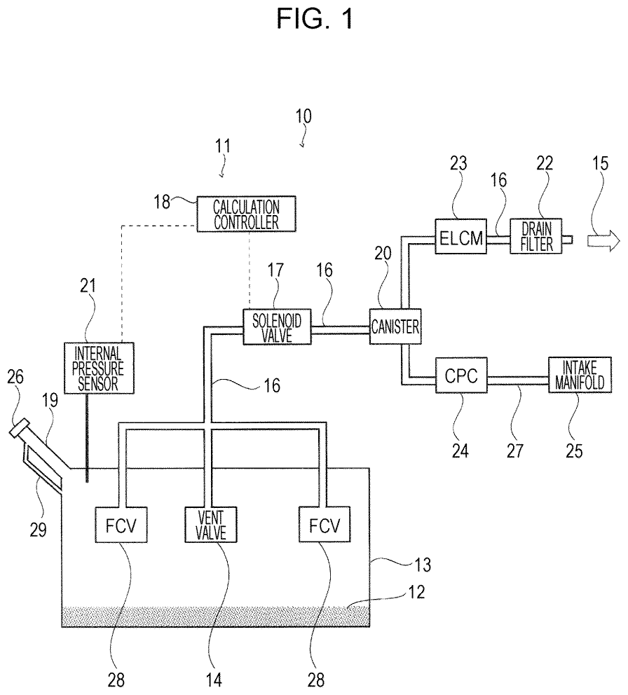

FIG. 1 is a block diagram illustrating the configuration of a vehicle 10 including the fuel tank processing apparatus 11.

The vehicle 10 is a moving apparatus including an engine. For example, the vehicle 10 may be an engine vehicle, an electric vehicle (EV), a hybrid electric vehicle (HEV), or a plug-in hybrid electric vehicle (PHEV). Alternatively, the vehicle 10 may be an EV including an engine as a range extender.

The fuel tank processing apparatus 11 is a device that appropriately controls gas 15 generated in a fuel tank 13 during refueling. The fuel tank processing apparatus 11 mainly includes a discharge path 16, a solenoid valve 17, and a calculation controller 18. The solenoid valve 17 may serve as a “valve”.

The fuel tank 13 is a device that stores fuel 12 to be supplied to an engine (not illustrated). The fuel 12 may be, for example, gasoline, light oil, or mixed oil.

A fuel feed pipe 19 is provided at the top of the fuel tank 13. The fuel feed pipe 19 is a substantially cylindrical device through which the fuel tank 13 communicates with the outside. The fuel feed pipe 19 receives a nozzle of a fuel-supplying device when the fuel 12 is supplied to the fuel tank 13. An outer end of the fuel feed pipe 19 is sealed with a cap 26.

An internal pressure sensor 21 is a device that measures the pressure in the fuel tank 13. An electric signal representing the internal pressure of the fuel tank 13 measured by the internal pressure sensor 21 is transmitted to the calculation controller 18.

The calculation controller 18 includes a CPU, a RAM, a ROM, and a timer and executes a predetermined calculation control process based on, for example, an input signal received from the internal pressure sensor 21. The calculation controller 18 adjusts an opening degree of the solenoid valve 17. As described below, the calculation controller 18 adjusts the opening degree of the solenoid valve 17 during supplying of the fuel 12 to the fuel tank 13 based on a change in condition that occurs when the internal pressure of the fuel tank 13 is reduced. The calculation controller 18 includes a storage unit. The storage unit stores a program for executing processes of the fuel tank processing apparatus 11 described below.

The discharge path 16 is a path along which the gas 15 discharged from the fuel tank 13 flows. The discharge path 16 is a pipe line through which a vent valve 14 communicates with the outside of the fuel tank 13 and through which the gas 15 discharged from the fuel tank 13 flows. The discharge path 16 is, for example, a pipe made of a synthetic resin, a metal, or the like. The gas 15 is gas vaporized from the fuel 12, air in the fuel tank 13, or a mixture of the vaporized gas and air.

Fuel cut valves (FCVs) 28, the vent valve 14, a solenoid valve 17, a canister 20, an evaporative leak check module (ELCM) 23, and a drain filter 22 are disposed in the discharge path 16 in that order from an upstream side of the flow of the gas 15.

The fuel path 27 is a pipe line that branches from the discharge path 16 at a location at which the canister 20 is disposed. The fuel path 27 is, for example, a pipe made of a synthetic resin, a metal, or the like.

The FCVs 28 are valves used to stop the fuel supply selectively, and are also referred to as fuel cut valves.

The vent valve 14 is disposed in the fuel tank 13 that stores the fuel 12. The vent valve 14 closes when the liquid level of the fuel 12 in the fuel tank 13 reaches or exceeds a predetermined level, and prevents the fuel 12 from flowing out.

The solenoid valve 17 is a device disposed in the discharge path 16. The solenoid valve 17 is coupled to an output terminal of the calculation controller 18. The opening/closing operation and the opening degree of the solenoid valve 17 are linearly controlled by the calculation controller 18 in a stepless manner. As described below, during refueling, the opening degree of the solenoid valve 17 is set to enable smooth refueling process while the amount of gas 15 discharged to the outside through the fuel feed pipe 19 and the discharge path 16 is appropriately controlled.

The canister 20 contains an adsorbent composed of, for example, activated carbon. Since the canister 20 contains the adsorbent, vaporized fuel contained in the gas 15 that is discharged from the fuel tank 13 and flows through the discharge path 16 can be adsorbed.

The ELCM 23 is also referred to as an evaporative leak check module. The ELCM 23 is a device that checks whether there is a leak in the fuel tank 13 or the canister 20.

The drain filter 22 is a filter for purifying the gas 15 that passes through the discharge path 16.

A canister purge control (CPC) valve 24 is also referred to as a purge control solenoid valve. An opening degree of the CPC valve 24 is set in accordance with a duty ratio of a control signal output from the calculation controller 18. During leakage diagnosis, the opening degree of the CPC valve 24 is adjusted in accordance with the diagnostic status. During normal control, the opening degree of the CPC valve 24 is controlled in accordance with the operational conditions.

An intake manifold 25 is a device that distributes air between intake ports of cylinders of an engine (not illustrated).

A gas passage pipe 29 is a substantially cylindrical duct having an upper end coupled to an intermediate portion of the fuel feed pipe 19 and a lower end coupled to the fuel tank 13. As described below, when the fuel 12 is supplied to the fuel tank 13, the gas 15 in the fuel tank 13 circulates through the gas passage pipe 29, the fuel feed pipe 19, and the fuel tank 13.

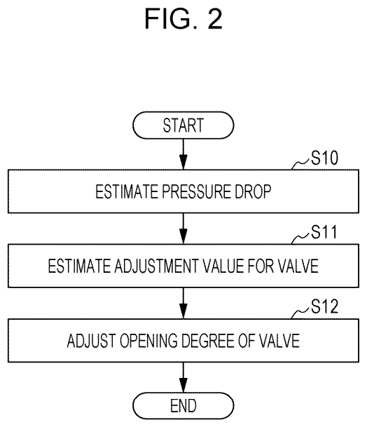

FIG. 2 is a flowchart of a method by which the fuel tank processing apparatus 11 changes the opening degree of the solenoid valve 17 during refueling of the fuel tank 13.

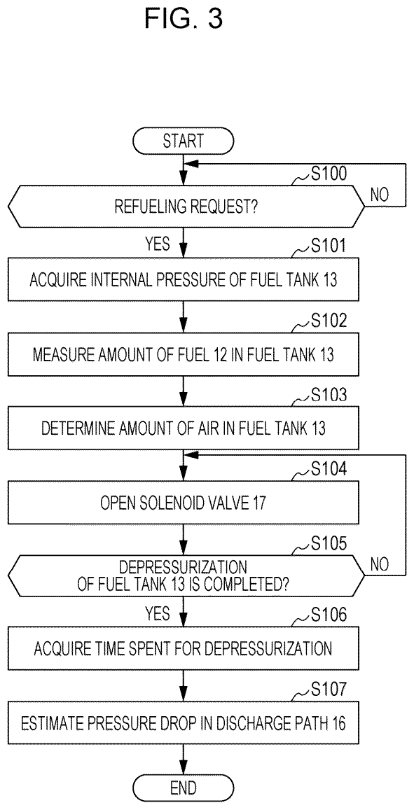

In step S10, the calculation controller 18 estimates the pressure drop in the discharge path 16. Step S10 will be described in detail with reference to FIG. 3.

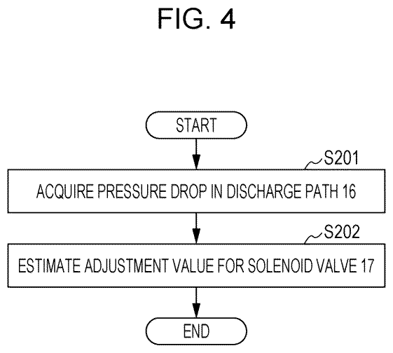

In step S11, the calculation controller 18 estimates an adjustment value for the solenoid valve 17. Step S11 will be described in detail with reference to FIG. 4.

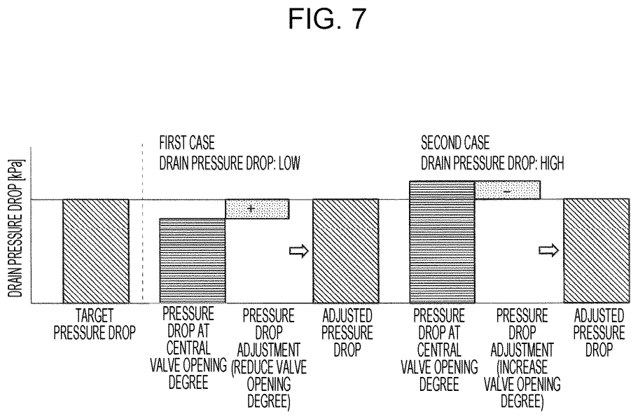

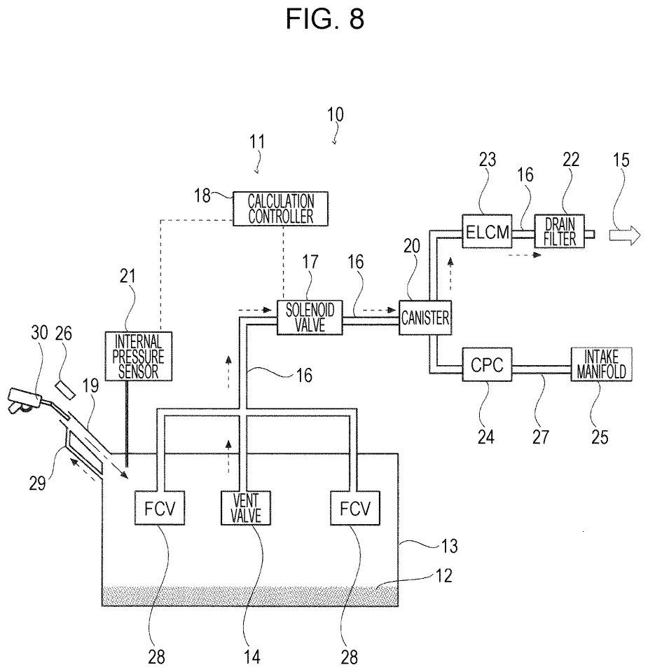

In step S12, the calculation controller 18 adjusts the opening degree of the solenoid valve 17. Step S12 will be described in detail with reference to FIGS. 7 and 8.

After these steps are completed, a user opens the cap 26 and supplies the fuel 12 to the fuel tank 13 through the fuel feed pipe 19. After the fuel 12 is supplied, the user closes the cap 26.

FIG. 3 is a flowchart illustrating step S10 described above in detail, that is, a flowchart of the method by which the calculation controller 18 of the fuel tank processing apparatus 11 estimates the pressure drop in the discharge path 16.

In step S100, the calculation controller 18 determines whether a refueling request has been issued. The refueling request is issued when, for example, an occupant of the vehicle 10 or an operator operates a fuel filler lever, button, or the like (not illustrated) to fill the fuel tank 13 with the fuel 12.

When the result of the determination is YES in step S100, that is, when a refueling request has been issued, the calculation controller 18 proceeds to step S101.

When the result of the determination is NO in step S100, that is, when no refueling request has been issued, the calculation controller 18 returns to START.

In step S101, the calculation controller 18 acquires the internal pressure of the fuel tank 13. For example, the calculation controller 18 causes the internal pressure sensor 21 to measure the internal pressure of the fuel tank 13.

In step S102, the calculation controller 18 causes a fuel level sensor (not illustrated) to measure the amount of the fuel 12 in the fuel tank 13.

In step S103, the calculation controller 18 determines the amount of air in the fuel tank 13. The amount of air in the fuel tank 13 is calculated by subtracting the amount of the fuel 12 in the fuel tank 13 from the total capacity of the fuel tank 13.

In step S104, the calculation controller 18 opens the solenoid valve 17 at a predetermined opening degree. For example, the calculation controller 18 sets the opening degree of the solenoid valve 17 to 50%.

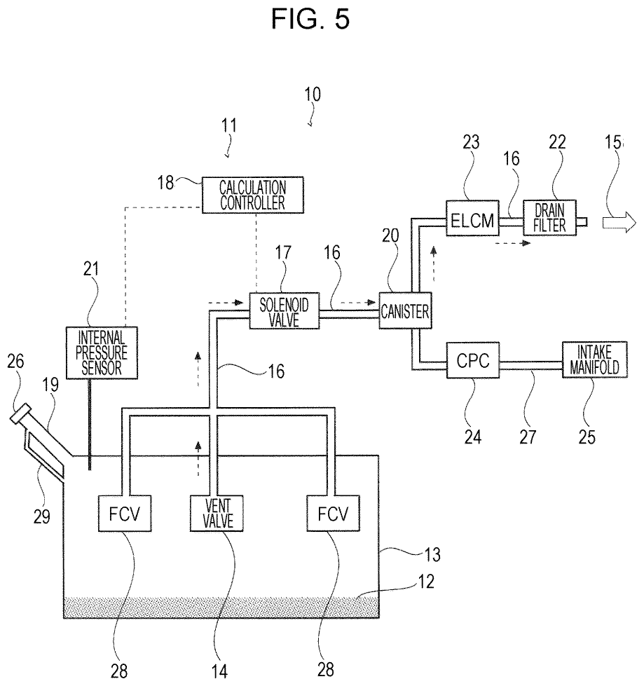

FIG. 5 is a block diagram illustrating the state in which the fuel tank 13 is depressurized in step S104. In FIG. 5, the dotted line arrow indicates the path along which the gas 15 in the fuel tank 13 is discharged. When the solenoid valve 17 is opened, the gas 15 in the fuel tank 13 is discharged to the outside of the fuel tank 13 through the discharge path 16. For example, the gas 15 flows from the fuel tank 13 to the outside of, for example, the vehicle through the solenoid valve 17, the canister 20, the ELCM 23, and the drain filter 22 disposed in the discharge path 16.

In step S105, the calculation controller 18 determines whether the depressurization of the fuel tank 13 is completed based on an output value of the internal pressure sensor 21. For example, the calculation controller 18 determines that the depressurization of the fuel tank 13 is completed when the internal pressure of the fuel tank 13 is equivalent to atmospheric pressure.

When the result of the determination is YES in step S105, that is, when the depressurization of the fuel tank 13 is completed, the calculation controller 18 proceeds to step S106.

When the result of the determination is NO in step S105, that is, when the depressurization of the fuel tank 13 is not completed, the calculation controller 18 returns to step S104.

In step S106, the calculation controller 18 acquires the time spent for the depressurization of the fuel tank 13.

In step S107, the calculation controller 18 calculates the pressure drop in the discharge path 16 when the solenoid valve 17 is opened at the predetermined opening degree.

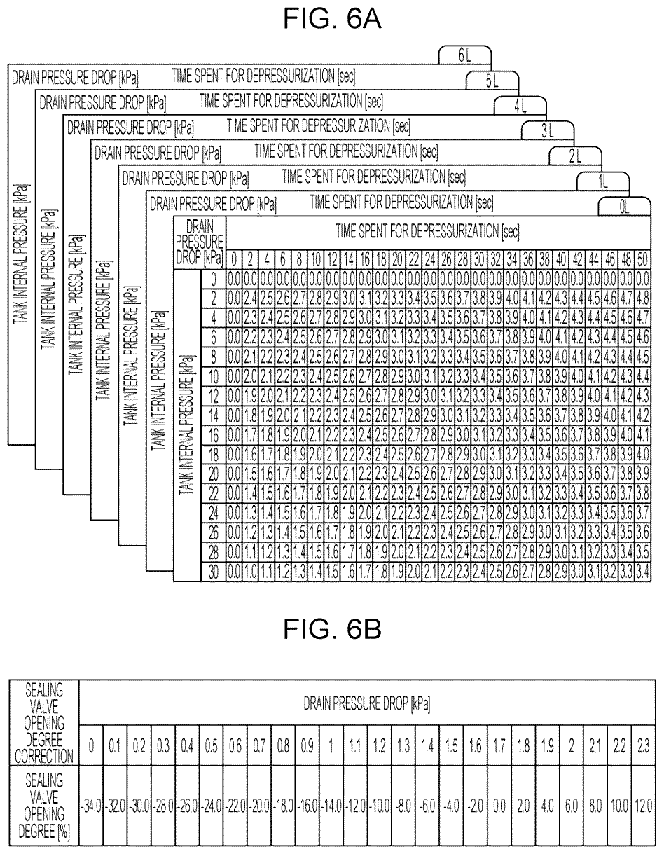

The operation of the calculation controller 18 in step S107 will be described with reference to FIGS. 6A and 6B. First, the pressure drop in the discharge path 16 is estimated from the amount of the fuel 12 in the fuel tank 13, the time spent for the depressurization, and the internal pressure of the fuel tank 13 by using correspondence tables illustrated in FIG. 6A.

The tables illustrated in FIG. 6A are correspondence tables used to estimate the pressure drop when the fuel tank 13 is depressurized by using the fuel tank processing apparatus 11. The correspondence tables are also referred to as look-up tables to which output values are allocated to input information in advance. In the correspondence tables illustrated in FIG. 6A, the input values are the time spent for the depressurization and the internal pressure of the fuel tank 13 before the depressurization. The time spent for the depressurization is, for example, the time spent to change the internal pressure of the fuel tank 13 to atmospheric pressure.

Here, the output value is the pressure drop in the discharge path 16, and is also referred to as a drain pressure drop. In the present embodiment, multiple correspondence tables are prepared in accordance with the amount of the fuel 12 in the fuel tank 13. For example, the correspondence tables are prepared for the amounts of fuel 12 in the range of 0 liter to 70 liter in steps of one liter.

The correlation between the time spent for the depressurization, the internal pressure of the fuel tank 13, the amount of the fuel 12 in the fuel tank 13, and the pressure drop in the discharge path 16 is very complex. In addition, the correlation depends on, for example, the degree to which the drain filter 22 is clogged, the state of adsorption in the canister 20, and the deformation of the pipes that constitute the discharge path 16, and cannot be uniquely determined. In light of the above-described complex correlation, according to the present embodiment, the correspondence tables are prepared in advance to enable simple and quick estimation of the pressure drop in the discharge path 16.

For example, when the amount of the fuel 12 in the fuel tank 13 is 0 liter, the time spent for the depressurization is 8 seconds, and the internal pressure of the fuel tank 13 is 28 kPa, the pressure drop in the discharge path 16 is estimated to be 1.4 kPa.

Step S11 described above, that is, the step of estimating the adjustment value for the opening degree of the solenoid valve 17 will be described with reference to FIG. 4.

In step S201, the calculation controller 18 acquires the above-described pressure drop in the discharge path 16.

In step S202, the calculation controller 18 estimate a correction value for the solenoid valve 17 based on the pressure drop in the discharge path 16.

Step S202 will be described with reference to the table of FIG. 6B. In this table, the values in the upper row represent the estimated pressure drops in the discharge path 16, and the values in the lower row represent the values for correcting the opening degree of the solenoid valve 17.

For example, assume that the opening degree of the solenoid valve 17 is 50% in step S104 described above, and the pressure drop in the discharge path 16 to be set is 1.7 kPa. When the pressure drop in the discharge path 16 estimated in step S107 described above is 1.4 kPa, the opening degree correction value is determined to be −6.0% by referring to the table illustrated in FIG. 6B. Thus, the opening degree of the solenoid valve 17 to be set is 44%.

FIG. 7 is a conceptual diagram illustrating the adjustment of the opening degree of the solenoid valve 17 performed by the fuel tank processing apparatus 11. A first case and a second case between which the estimated pressure drop differs will now be described.

In the first case, the estimated pressure drop is less than the target pressure drop. Therefore, the opening degree of the solenoid valve 17 is reduced to increase the pressure drop in the discharge path 16 to a value equivalent to the target pressure drop.

In the second case, the estimated pressure drop is greater than the target pressure drop. Therefore, the opening degree of the solenoid valve 17 is increased to reduce the pressure drop in the discharge path 16 to a value equivalent to the target pressure drop.

Thus, the pressure drop in the discharge path 16 approaches the target pressure drop, so that the gas 15 is appropriately discharged to the outside through the discharge path 16, and the gas 15 is also circulated around the fuel feed pipe 19 during refueling as described below.

FIG. 8 is a block diagram illustrating paths for the gas 15 during refueling. The cap 26 is removed from the fuel feed pipe 19, and a nozzle of a fuel-supplying device 30 is inserted into the fuel feed pipe 19. In this state, the fuel 12 is supplied to the fuel tank 13 through the fuel-supplying device 30.

A portion of the gas 15 in the fuel tank 13 is discharged to the outside through the discharge path 16 during refueling. Another portion of the gas 15 is circulated through the gas passage pipe 29, the fuel feed pipe 19, and the fuel tank 13.

In the present embodiment, as described above, the opening degree of the solenoid valve 17 is adjusted so that the pressure drop in the discharge path 16 is close to the target value. Therefore, a portion of the gas 15 is appropriately discharged to the outside through the discharge path 16. Another portion of the gas 15 is appropriately circulated through the fuel tank 13, the gas passage pipe 29, and the fuel feed pipe 19. Thus, leakage of the gas 15 to the outside, for example, may be controlled to comply with the laws and regulations of each country. In addition, the fuel 12 can be smoothly supplied.

The technical idea that can be grasped from the above-described embodiment will be described below together with the effects thereof.

A fuel tank processing apparatus according to an embodiment of the disclosure includes a discharge path, a valve, and a calculation controller. Gas discharged from a fuel tank flows through the discharge path. The valve is disposed in the discharge path. The calculation controller is configured to adjust an opening degree of the valve. The calculation controller is configured to adjust the opening degree of the valve during supplying of fuel to the fuel tank based on a change in condition that occurs when an internal pressure of the fuel tank is reduced. According to the fuel tank processing apparatus of the embodiment of the disclosure, the pressure drop in the discharge path may be set to an appropriate value by adjusting the opening degree of the valve based on the change in condition of the fuel tank. Thus, the fuel can be smoothly supplied to the fuel tank while setting the amounts of gas that flows through the fuel feed pipe and the discharge path to appropriate values.

In the fuel tank processing apparatus according to the embodiment of the disclosure, the calculation controller is configured to estimate a pressure drop in the discharge path based on the change in condition, and adjust the opening degree of the valve based on the pressure drop. According to the fuel tank processing apparatus of the embodiment of the disclosure, even when, for example, the pipe lines in the discharge path deteriorate, the pressure drop in the discharge path can be appropriately adjusted in accordance with the conditions of the discharge path.

In the fuel tank processing apparatus according to the embodiment of the disclosure, the calculation controller is configured to estimate the pressure drop in the discharge path based on a time spent to depressurize the fuel tank, the internal pressure of the fuel tank, and an amount of the fuel in the fuel tank. According to the fuel tank processing apparatus of the embodiment of the disclosure, the pressure drop in the discharge path can be accurately estimated.

In the fuel tank processing apparatus according to the embodiment of the disclosure, the calculation controller is configured to, in response to an operation for supplying the fuel, open the valve to discharge the gas from the fuel tank to outside, estimate a pressure drop in the discharge path based on the change in condition that occurs when the valve is opened, and adjust the opening degree of the valve based on the pressure drop when the fuel is supplied to the fuel tank. According to the fuel tank processing apparatus of the embodiment of the disclosure, the pressure drop in the discharge path is estimated before the fuel is supplied, and the opening degree of the valve is adjusted based on the pressure drop. Therefore, the gas can be appropriately discharged from the fuel tank to the outside, and the fuel can be smoothly supplied to the fuel tank.

While embodiments of the disclosure are described above, the disclosure is not limited to the embodiments, and changes are possible without departing from the gist of the disclosure. In addition, the above-described embodiments may be applied in combination with each other.

The calculation controller 18 illustrated in FIGS. 1, 5, and 8 can be implemented by circuitry including at least one semiconductor integrated circuit such as at least one processor (e.g., a central processing unit (CPU)), at least one application specific integrated circuit (ASIC), and/or at least one field programmable gate array (FPGA). At least one processor can be configured, by reading instructions from at least one machine readable tangible medium, to perform all or a part of functions of the calculation controller 18. Such a medium may take many forms, including, but not limited to, any type of magnetic medium such as a hard disk, any type of optical medium such as a CD and a DVD, any type of semiconductor memory (i.e., semiconductor circuit) such as a volatile memory and a non-volatile memory. The volatile memory may include a DRAM and a SRAM, and the non-volatile memory may include a ROM and a NVRAM. The ASIC is an integrated circuit (IC) customized to perform, and the FPGA is an integrated circuit designed to be configured after manufacturing in order to perform, all or a part of the functions of the modules illustrated in FIGS. 1, 5, and 8.

1. A fuel tank processing apparatus comprising:
a discharge path through which gas discharged from a fuel tank is to flow;
a valve disposed in the discharge path; and
a calculation controller configured to adjust an opening degree of the valve,
wherein the calculation controller is configured to adjust the opening degree of the valve during supplying of fuel to the fuel tank based on a change in condition that occurs when an internal pressure of the fuel tank is reduced.

2. The fuel tank processing apparatus according to claim 1,
wherein the calculation controller is configured to
estimate a pressure drop in the discharge path based on the change in condition, and
adjust the opening degree of the valve based on the pressure drop.

3. The fuel tank processing apparatus according to claim 2,
wherein the calculation controller is configured to
estimate the pressure drop in the discharge path based on a time spent to depressurize the fuel tank, the internal pressure of the fuel tank, and an amount of the fuel in the fuel tank.

4. The fuel tank processing apparatus according to claim 1,
wherein the calculation controller is configured to, in response to an operation for supplying the fuel,
open the valve to discharge the gas from the fuel tank to outside,
estimate a pressure drop in the discharge path based on the change in condition that occurs when the valve is opened, and
adjust the opening degree of the valve based on the pressure drop when the fuel is supplied to the fuel tank.

5. A fuel tank processing apparatus comprising:
a discharge path through which gas discharged from a fuel tank is to flow;
a valve disposed in the discharge path; and
circuitry configured to adjust an opening degree of the valve,
wherein the circuitry is configured to adjust the opening degree of the valve during supplying of fuel to the fuel tank based on a change in condition that occurs when an internal pressure of the fuel tank is reduced.
